(19) United States
(12) Patent Application Publication
(10) Pub. No.: US 2003/0054862 A1
(43) Pub. Date: Mar. 20, 2003

(54) Method for checking user information of a mobile telephone in a locked state and automatically calling the user

(75) Inventors: Chan-Byoung Chae, Songnam-shi (KR); Jae-Am Choi, Yongin-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., Kyungki-Do (KR)

(21) Appl. No.: 10/241,067

(22) Filed: Sep. 11, 2002

(30) Foreign Application Priority Data
Sep. 19, 2001 (KR) P2001-57917

(51) Int. Cl. H04B 1/38

(52) U.S. Cl. 455/565; 455/564; 455/566

(57) ABSTRACT

A method for controlling a mobile telephone in which user information and an automatic call number are previously registered in the mobile telephone. Upon receiving a user information check request and an automatic call request in a locked mode, the mobile telephone outputs the registered user information and connects a call to the registered automatic call number.

### PRIORITY

This application claims priority to an application entitled “Method for Checking User information of a Mobile Telephone in Locked State and Automatically Calling the User” filed in the Korean Industrial Property Office on Sep. 19, 2001 and assigned Serial No. 2001-57917, the contents of which are hereby incorporated by reference.

### BACKGROUND OF THE INVENTION

1. Field of the Invention

The present invention relates generally to a method for controlling a mobile telephone, and in particular, to a method for checking user information of a mobile telephone that is in a locked state and automatically calling a user of the mobile telephone.

2. Description of the Related Art

With the progress of modem society, an increasing number of individuals use mobile telephones. Consequently, illegal use of mobile telephones by unauthorized persons has also increased. In order to prevent the illegal use of a mobile telephone by another person, a user sets a locking function by registering a password in his or her mobile telephone.

However, when the user loses his or her mobile telephone with its locking function set, another person, though he or she found the missing mobile telephone, cannot hand back the found mobile telephone to the user because the finder cannot check the user's information in the found mobile telephone.

### SUMMARY OF THE INVENTION

It is, therefore, an object of the present invention to provide a method for checking user information in a mobile telephone in a locked state.

It is further another object of the present invention to provide a method for automatically calling a user of a missing mobile telephone in a locked state.

According to a first aspect of the present invention, there is provided a method for checking user information of a mobile telephone in a locked state. The method comprises registering user information input by a user, switching an operation mode of the mobile telephone to a locked mode, if a preset automatic locking time period has elapsed after registering the user information, and outputting the user information upon detecting a user infonnation check request in the locked mode.

According to a second aspect of the present invention, there is provided a method for automatically calling a user of a mobile telephone in a locked state. The method comprises registering an automatic call number input by a user, switching an operation mode of the mobile telephone to a locked mode if a preset automatic locking time period has elapsed after registering the automatic call number, and connecting a call to the registered automatic call number upon detecting an automatic call request in the locked mode.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating an internal structure of a mobile telephone to which an embodiment of the present invention is applicable;

FIG. 2 is a flow chart illustrating a procedure for registering user information according to an embodiment of the present invention;

FIG. 3 is a flow chart illustrating a procedure for checking user information in a locked state according to an embodiment of the present invention;

FIG. 4 is a flow chart illustrating a procedure for registering an automatic call number according to an embodiment of the present invention; and

FIG. 5 is a flow chart illustrating a procedure for automatically calling a user of a mobile telephone in a locked stated according to an embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

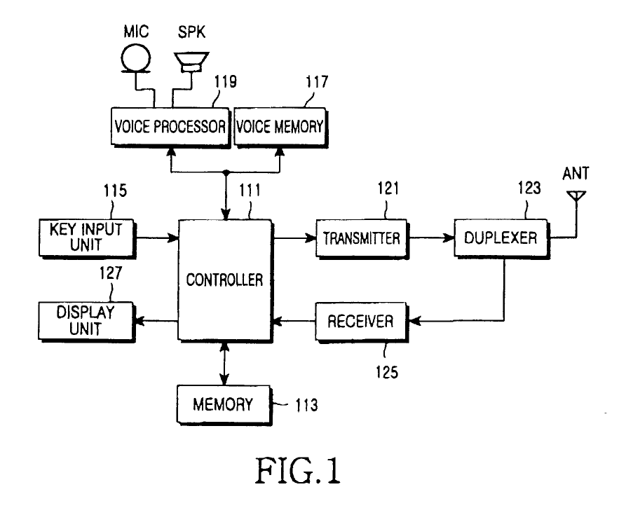

FIG. 1 is a block diagram illustrating an internal structure of a mobile telephone to which an embodiment of the present invention is applicable. Referring to FIG. 1, a controller 111 controls the overall operation of the mobile telephone. A memory 113 stores a control program of the mobile telephone and control data generated while the controller 111 controls the mobile telephone. Particularly, in the embodiment of the present invention, the memory 113 stores user information in the mobile telephone while it is in a locked state. For example, the user information includes a name of the telephone user and a unique telephone number of the mobile telephone.

A key input unit 115 includes a plurality of dialing digit keys, a Menu key and a Send key. The key input unit 115 generates a key signal corresponding to a key selected (or pressed) by the user and provides the generated key signal to the controller 111. In particular, the key input unit 115 includes a User Information Check key and an Automatic Call key. The User Information Check key is used to check user information of the mobile telephone when the mobile telephone is in a locked state, and the Automatic Call key is used to call the user of the mobile telephone in the locked state. Here, the User Information Check key and the Automatic Call key can be realized by combining a plurality of keys included in the key input unit 115, or specific keys can be separately prepared for the User Information Check key and the Automatic Call key.

A voice memory 117 stores a plurality of voice messages, and a voice processor 119, under the control of the controller 111, converts a voice message read from the voice memory 117 into an analog voice signal and outputs the voice signal through a SPK (speaker). Further, the voice processor 119 converts an analog voice signal received from the user through a MIC (microphone) into a digital voice signal.

A transmitter 121 modulates a signal generated by the controller 111 into an RF (Radio Frequency) signal and provides the RF signal to a duplexer 123. The duplexer 123 transmits the RF signal provided from the transmitter 121 through an ANT (antenna). Further, the duplexer 123 provides an RF signal received through the ANT to a receiver 125. The receiver 125 demodulates the RF signal provided from the duplexer 123, and provides the demodulated signal to the controller 111. The controller 111 controls a call according to the demodulated signal provided from the receiver 125. A display unit 127, realized by an LCD (Liquid Crystal Display) and an LED (Light Emitting Diode), displays input data and control data of the mobile telephone under the control of the controller 111.

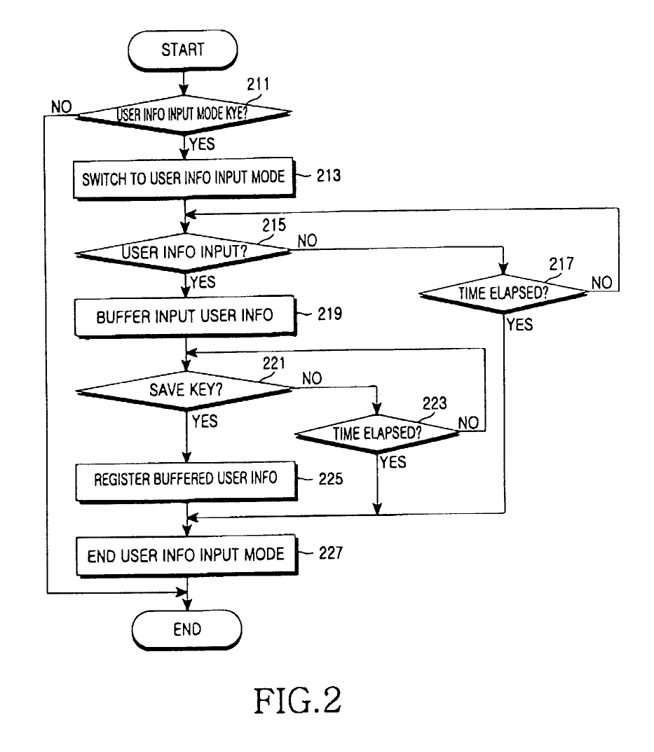

FIG. 2 is a flow chart illustrating a procedure for registering user information according to an embodiment of the present invention. Referring to FIG. 2, the controller 111 determines in step 211 whether a User Information Input Mode key is input from the key input unit 115 in an idle mode. As a result of the determination, if the User Information Input Mode key is not input from the key input unit 115, the controller 111 ends the procedure. However, if the User Information Input Mode key is input from the key input unit 115 in step 211, the controller 111 proceeds to step 213. In step 213, the controller 111 switches an operation mode of the mobile telephone from the idle mode to a user information input mode, and then proceeds to step 215. In step 215, the controller 111 determines whether user information of the mobile telephone, for example, a user name and a unique telephone number of the mobile telephone, is input from the key input unit 115. Of course, the user information is input by the user using the keys included in the key input unit 115.

If the user information is not input in step 215, the controller 111 proceeds to step 217. In step 217, the controller 111 determines whether a preset time period, e.g., 5 seconds, has elapsed. As a result of the determination, if the preset time period has not yet elapsed, the controller 111 returns to step 215. Otherwise, if the preset time period has elapsed, the controller 111 proceeds to step 227 and ends the user information input mode. However, if the user information is input in step 215, the controller 111 proceeds to step 219. In step 219, the controller 111 buffers the input user information, and then proceeds to step 221. In step 221, the controller 111 determines whether a Save key is input from the key input unit 115. If the Save key is not input, the controller 111 proceeds to step 223. In step 223, the controller 111 determines whether a preset time period, e.g., 5 seconds, has elapsed. If the preset time period-has not yet elapsed, the controller 111 returns to step 221. If the preset time period has elapsed in step 223, the controller 111 proceeds to step 227.

However, if the Save key is input in step 221, the controller 111 proceeds to step 225. In step 225, the controller 111 registers the buffered user information in the memory 113 as user information of the mobile telephone, and then proceeds to step 227. In step 227, the controller 111 ends the user information input mode and switches to the idle mode, and then ends the procedure.

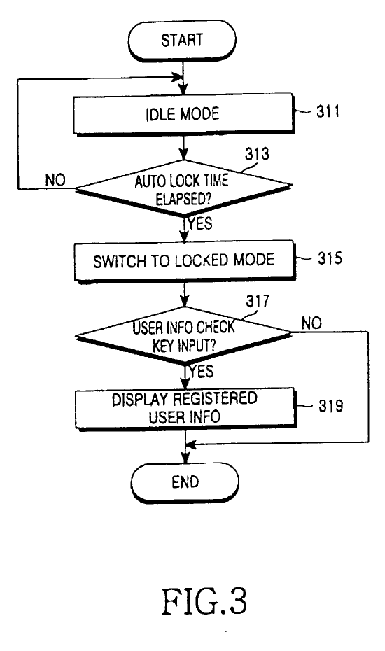

FIG. 3 is a flow chart illustrating a procedure for checking user information in a locked state according to an embodiment of the present invention. Referring to FIG. 3, the controller 111 performs an idle mode in step 311, and then proceeds to step 313. In step 313, the controller 111 determines whether a preset automatic locking time period has elapsed. Here, though not illustrated, the process of determining the automatic locking time period indicates a process in which the mobile telephone is automatically switched to a locked state after a lapse of a preset time period, e.g., 30 minutes. As a result of the determination in step 313, if the automatic locking time period has not elapsed yet, the controller 111 returns to step 311.

However, if the automatic locking time period has elapsed in step 313, the controller 111 proceeds to step 315. In step 315, the controller 111 switches an operation mode of the mobile telephone from the idle mode to a locked mode, and then proceeds to step 317. In step 317, the controller 111 determines whether a User Information Check key is input from the key input unit 115. Here, the User Information Check key is a key input to check user information of the mobile telephone. When the mobile telephone is in the locked mode, if the User Information Check key is input, it is possible to check user information of the mobile telephone even in the locked state.

As a result of the determination in step 317, if the User Information Check key is not input, the controller 111 ends the procedure while maintaining the locked mode. However, if the User Information Check key is input in step 317, the controller 111 proceeds to step 319. In step 319, the controller 111 displays the user information registered in the memory 113 on the display unit 127, and then ends the procedure.

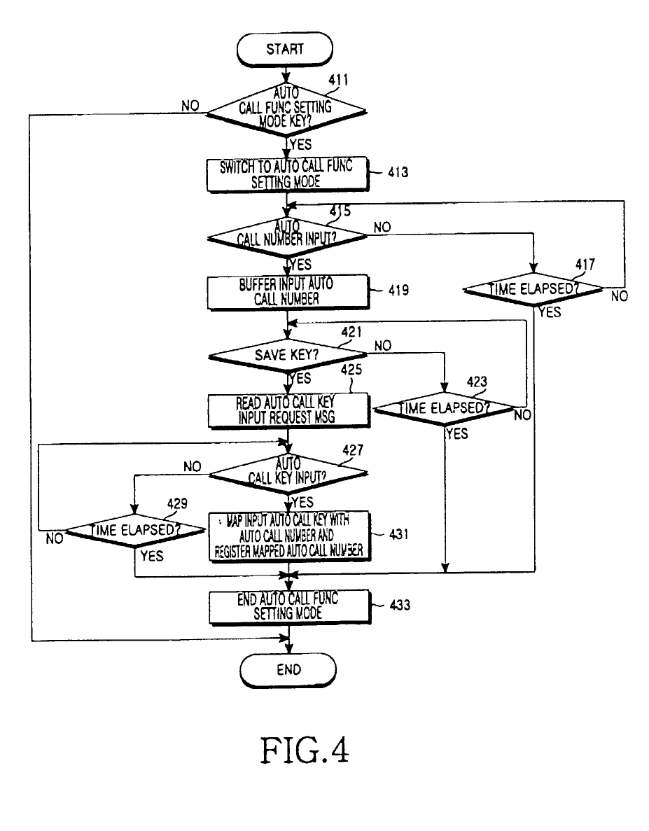

FIG. 4 is a flow chart illustrating a procedure for registering an automatic call number according to an embodiment of the present invention. Referring to FIG. 4, the controller 111 determines in step 411 whether an Automatic Call Function Setting Mode key is input from the key input unit 115 in the idle mode. As a result of the determination, if the Automatic Call Function Setting Mode key is not input, the controller 111 ends the procedure. However, as a result of the determination in step 411, if the Automatic Call Function Setting Mode key is input from the key input unit 115, the controller 111 proceeds to step 413. In step 413, the controller 111 switches an operation mode of the mobile telephone from the idle mode to the automatic call function setting mode, and then proceeds to step 415.

In step 415, the controller 111 determines whether an automatic call number is input from the key input unit 115. If an automatic call number is not input from the key input unit 115, the controller 111 proceeds to step 417. In step 417, the controller 111 determines whether a preset time period, e.g., 5 seconds has elapsed. If the preset time period has not elapsed yet, the controller 111 returns to step 415. Otherwise, if the preset time period has elapsed, the controller 111 proceeds to step 433 and ends the automatic call function setting mode.

However, if an automatic call number is input from the key input unit 115 in step 415, the controller 111 proceeds to step 419. In step 419, the controller 111 buffers the input automatic call number, and then proceeds to step 421. In step 421, the controller 111 determines whether a Save key is input from the key input unit 115. If the Save key is not input, the controller 111 proceeds to step 423. In step 423, the controller 111 determines whether a preset time period, i.e., 5 seconds has elapsed. If the preset time period has not elapsed yet, the controller 111 returns to step 421. However, if the preset time period has elapsed, the controller 111 proceeds to step 433.

However, if the Save key is input from the key input unit 115 in step 421, the controller 111 proceeds to step 425. In step 425, the controller 111 reads an automatic call key input request message previously stored in the memory 113 and displays the read automatic call key input request message on the display unit 127 to request the user to input the Automatic Call key, and then proceeds to step 427. Here, the “Automatic Call key” means an automatic call number of the mobile telephone, and is a kind of a command key for dialing the automatic call number in order to actually connect a call.

In step 427, the controller 111 determines whether an Automatic Call key to be mapped with the automatic call number is input from the key input unit 115. If the Automatic Call key is not input from the key input unit 115, the controller 111 proceeds to step 429. In step 429, the controller 111 determines whether a preset time period, e.g., 5 seconds has elapsed. If the preset time has not elapsed yet, the controller 111 returns to step 427. If the preset time period has elapsed, the controller 111 proceeds to step 433.

However, if the Automatic Call key is input from the key input unit 115 in step 427, the controller 111 proceeds to step 431. In step 431, the controller 111 maps the input Automatic Call key to the buffered automatic call number, registers the mapped automatic call number in the memory 113, and then proceeds to step 433. In step 433, the controller 111 ends the automatic call function setting mode, switches an operation mode of the mobile telephone to the idle mode, and then ends the procedure.

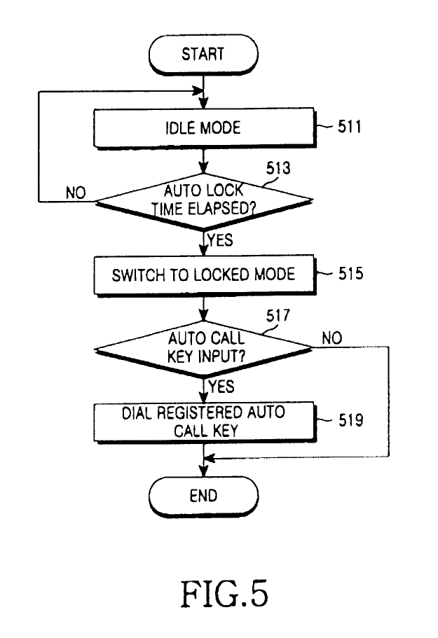

FIG. 5 is a flow chart illustrating a procedure for automatically calling a user of a mobile telephone in a locked stated according to an embodiment of the present invention. Referring to FIG. 5, the controller 111 performs an idle mode in step 511, and then proceeds to step 513. In step 513, the controller 111 determines whether a preset automatic locking time period has elapsed. Here, though not illustrated, the process of determining the automatic locking time period indicates a process in which the mobile telephone is automatically switched to a locked state after a lapse of a preset time period, e.g., 30 minutes. As a result of the determination in step 513, if the automatic locking time period has not elapsed yet, the controller 111 returns to step 511.

However, if the automatic locking time period has elapsed in step 513, the controller 111 proceeds to step 515. In step 515, the controller 111 switches an operation mode of the mobile telephone from the idle mode to a locked mode, and then proceeds to step 517. In step 517, the controller 111 determines whether an Automatic Call key is input from the key input unit 115. If the Automatic Call key is not input from the key input unit 115, the controller 111 ends the procedure. However, if the Automatic Call key is input from the key input unit 115, the controller 111 proceeds to step 519. In step 519, the controller 111 dials the automatic call number registered in the memory 113 to connect a call, enabling the finder of the mobile phone to alert the user of the mobile phone that the mobile phone has been found.

As described above, the present invention previously registers user information and an automatic call number in a mobile telephone, so even an unauthorized person can check the user information by inputting a User Information Check key of the mobile telephone that is in a locked state. In addition, the unauthorized person can automatically dial the automatic call number by inputting an Automatic Call key. Therefore, even though the user loses the mobile telephone with the locking function set, the finder of the missing mobile telephone can contact the user (owner) of the mobile telephone by checking the user information of the mobile telephone and performing the automatic call function, thus offering convenience to the user.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for checking user information of a mobile telephone in a locked state, comprising the steps of:
registering user information input by a user;
switching an operation mode of the mobile telephone to a locked mode, if a preset automatic locking time period has elapsed after registering the user information; and
outputting the user information upon detecting a user information check request in the locked mode.

2. The method of claim 1, wherein the step of registering the user information comprises the steps of:
switching an operation mode of the mobile telephone to a user information input mode upon detecting a user information input request;
inputting the user information in the user information input mode; and
registering the input user information.

3. The method of claim 1, wherein the user information includes a user name and a unique telephone number of the mobile telephone.

4. A method for automatically calling a user of a mobile telephone in a locked state, comprising the steps of:
registering an automatic call number input by a user;
switching an operation mode of the mobile telephone to a locked mode if a preset automatic locking time period has elapsed after registering the automatic call number; and
connecting a call to the registered automatic call number upon detecting an automatic call request in the locked mode.

5. The method of claim 4, wherein the step of registering the automatic call number comprises the steps of:
switching an operation mode of the mobile telephone to an automatic call function setting mode upon detecting an automatic call function setting request;
inputting the automatic call number in the automatic call function setting mode;
mapping the input automatic call key with the automatic call number, and registering the mapped automatic call number as the automatic call number for the mobile telephone.
